(19) United States
(12) Patent Application Publication
(10) Pub. No.: US 2019/0387321 A1
(43) Pub. Date: Dec. 19, 2019

(54) DIAPHRAGM FOR AN ACOUSTIC RECEIVER, COMBINATIONS THEREOF AND METHODS THEREFOR

(71) Applicant: Knowles Electronics, LLC, Itasca, IL (US)

(72) Inventors: Paul Dayton, Wayne, IL (US); Christopher Monti, Elgin, IL (US); Jose Salazar, Chicago, IL (US); Shehab Albahri, Hanover Park, IL (US); Daniel Warren, Geneva, IL (US); Charles King, Chicago, IL (US); Christopher Gabel, Bloomingdale, IL (US)

(21) Appl. No.: 16/484,908

(22) PCT Filed: Feb. 9, 2018
(86) PCT No.: PCT/US2018/017536

§ 371 Date: Aug. 9, 2019

Related U.S. Application Data
(60) Provisional application No. 62/456,919, filed on Feb. 9, 2017.

(51) Int. Cl. H04R 7/04; H04R 11/02; H04R 7/16; H04R 31/00

(52) U.S. Cl. CPC H04R 7/04; H04R 11/02; H04R 2307/025; H04R 31/003; H04R 2207/021; H04R 7/16

(57) ABSTRACT

In accordance with one aspect, a diaphragm for an acoustic receiver is provided that includes a frame, a paddle flexibly coupled to the frame, and a gap between a portion of the paddle and the frame. The diaphragm further includes siloxane material coupled to at least a portion of the paddle and to at least a portion of the frame. The siloxane material covers the gap. In another aspect, a method is provided for making an acoustic receiver diaphragm.

### TECHNICAL FIELD

This disclosure relates to acoustic devices and, more specifically, to diaphragms for acoustic transducers, combinations thereof, and methods therefor.

### BACKGROUND

Armature receivers capable of producing an acoustic output signal in response to an electrical input signal are known generally. Such receivers typically include a coil disposed about an armature at least a portion of which is movable between permanent magnets retained by a yoke when the electrical input signal is applied to the coil. These and other components are typically disposed within a housing of the receiver. The movable portion of the armature is linked to a movable portion of a diaphragm that separates the housing into front and back volume portions. Movement of the diaphragm creates the acoustic output signal at an output port of the receiver housing.

### BRIEF DESCRIPTION OF THE DRAWINGS

For a more complete understanding of the disclosure, reference should be made to the following detailed description and accompanying drawings wherein:

FIG. 1 is a cross-sectional view of a receiver having a diaphragm comprising a layer of silicone material and a diaphragm body including a paddle and a frame bonded to the layer of silicone material;

FIG. 2 is an enlarged view of the circled area of FIG. 1 showing portions of the diaphragm;

FIG. 3 is a plan view of one embodiment of a diaphragm body having torsional hinges;

FIG. 4 is a plan view of another embodiment of a diaphragm body having cantilevered hinges;

FIG. 5 is a flow chart showing a method of making a diaphragm;

FIG. 6 is a schematic view of a layer of silicone material extending between a paddle and a frame showing slack in the silicone material extending toward a front volume;

FIG. 7 is a schematic view of a layer of silicone material extending between a paddle and a frame showing slack in the silicone material extending away from the front volume;

FIG. 8 is a schematic view of a layer of silicone material extending between a paddle and a frame showing a roll of the silicone material extending toward a front volume;

FIG. 9 is a schematic view of a layer of silicone material extending between a paddle and a frame showing a roll of the silicone material extending away from a front volume;

FIG. 10 is a schematic view of a layer of silicone material extending between a paddle and a frame showing a pre-molded shape of the silicone material extending toward a front volume; and

FIG. 11 is a schematic view of a layer of silicone material extending between a paddle and a frame wherein the silicone material is directly molded to the paddle and frame.

FIG. 12 is a plan view of one embodiment of a diaphragm having a gap between a paddle and a frame of the diaphragm that varies in width about the paddle;

Those of ordinary skill in the art will appreciate that elements in the figures are illustrated for simplicity and clarity. It will be appreciated further that certain actions and/or steps may be described or depicted in a particular order of occurrence while those having ordinary skill in the art will understand that such specificity with respect to sequence is not actually required. It will also be understood that the terms and expressions used herein have the ordinary meaning as is accorded to such terms and

### DETAILED DESCRIPTION

In one aspect, a diaphragm for an acoustic receiver is provided that includes a frame, a paddle flexibly coupled to the frame, and a gap disposed between a portion of the paddle and the frame. The diaphragm further includes a siloxane material, such as siloxane, bonded to at least a portion of the paddle and bonded to at least a portion of the frame. In one approach, the siloxane material is bonded to the at least a portion of the frame without using adhesive. The siloxane material covers the gap between the frame and the paddle. The siloxane material may be resistant to high temperatures without melting, such as above 300° C., which allows the diaphragm to be exposed to a temperature above a solder reflow temperature, such as up to 240° C. This permits the receiver containing the diaphragm to be put through a solder reflow process, such as on an assembly line, to cause solder in the receiver to reflow and secure electrical connections. By contrast, some prior receivers utilize a diaphragm with a urethane film having a melting temperature below typical solder reflow temperatures. These prior receivers may require hand-soldering of the components of the receiver which may be labor intensive.

Another advantage of the diaphragm containing the siloxane material is that the siloxane material may not react with chemicals used during receiver manufacturing, such as acetone and alcohol. By contrast, some prior diaphragms that contain mylar (polyester) film and an adhesive or a urethane film and an adhesive may react with these chemicals. The siloxane material and non-adhesive bonding method thereby permits the use of acetone and alcohol which may be desirable in some applications.

In one form, the siloxane material is a deformable elastic material and the paddle is movable relative to the frame upon deformation of the siloxane material. The siloxane material may have a flat portion extending across a gap between the paddle and the frame, and the paddle is movable relative to the frame upon deformation of the siloxane material rather than utilizing a fold in the siloxane material extending across the gap. Because the portion of the siloxane material covering the gap lacks a fold, the portion of the siloxane material covering the gap is less likely to capture debris within the receiver. Further, the flat portion of the siloxane material extending across the gap may permit the overall height of the diaphragm may be minimized.

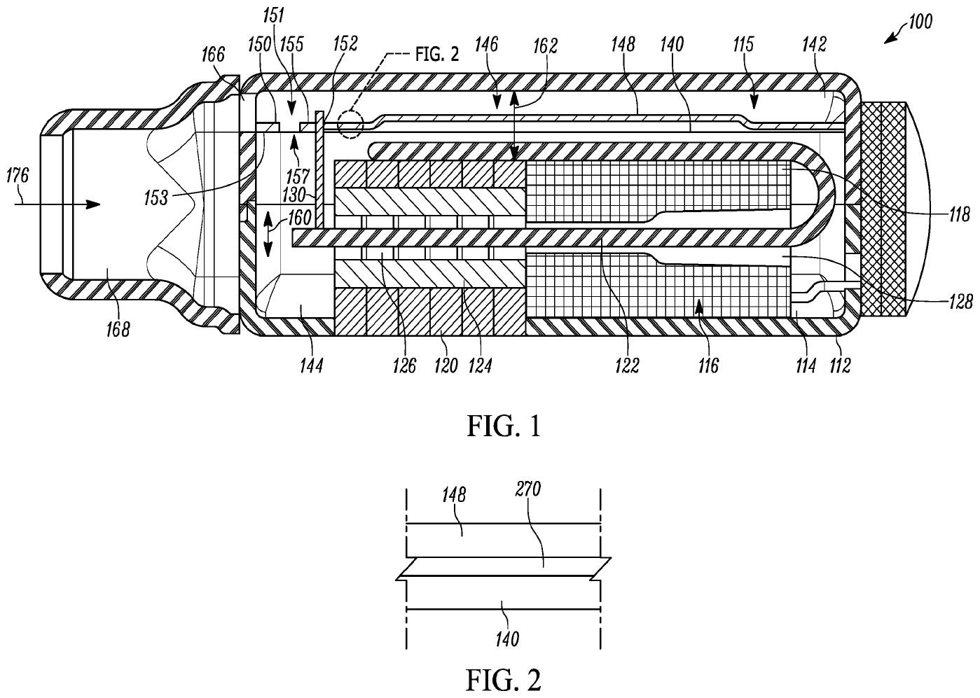

With reference to FIG. 1, a receiver 100 is provided that includes a housing 112 having an interior 114 that contains a diaphragm 115 that is movable to create sound and a motor 116 for driving the diaphragm 115. The diaphragm 115 separates the interior 114 into a front volume 142 and a back volume 144.

The diaphragm 115 includes a flexible membrane, for example a siloxane material such as silicone material 140. The siloxane material is understood to include silicones (of which the siloxane functional group forms the so-called backbone). In addition, the material could include additives such as but not limited to SiO2 filler, MQ-resin filler, transition metal oxide fillers (such as but not limited to TiO2) and calcite compounds, as well as an adhesion promoter for hydrophilic surfaces. The siloxane, adhesives, and other materials of the diaphragm 115 may be selected so that the diaphragm 115 can withstand reflow temperatures, of example 235° C., without significant degradation of performance.

The flexible membrane may also be constructed of various materials such as a polyurethane, ethylene vinyl copolymer (EVAL), n-butylacrylates/PMMA copolymer, ethylene propylene diene copolymer (EPDM), styrene-butadiene copolymers, siloxane copolymer, grafted siloxane, or any other flexible membrane. Other examples of materials are possible.

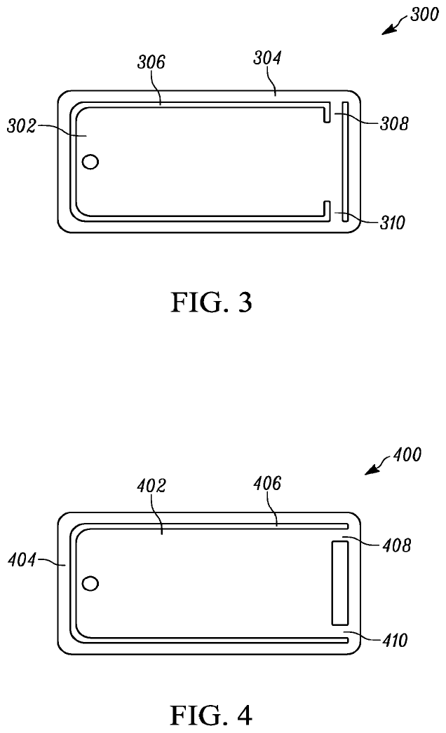

The diaphragm 115 also includes a diaphragm body 146 that comprises a paddle 148, a frame 150, and one or more hinges connecting the paddle 148 and the frame 150. One example of such hinges are torsional hinge members 308, 310 shown in FIG. 3. Another example of such hinges are the cantilever hinge members 408, 410 shown in FIG. 4. Returning to FIG. 1, the paddle 148 and the frame 150 may be a single, unassembled member, i.e., monolithic, or may be a plurality of pieces assembled together. An unassembled diaphragm body may be formed from a single piece of material by, for example, stamping, routing, milling etching, and/or grown methods. The diaphragm body may also be formed by three-dimensional printing or by some other process.

The diaphragm body 146 includes a gap 151 between portions 153, 155 of the paddle 148 and the frame 150. In some embodiments, the gap 151 defines the paddle 148 and the one or more hinges of the diaphragm body 146. The silicone material may be applied as a layer disposed on an entire surface of the diaphragm body 146 or on only select portions of the frame 150 and paddle 148 so that the silicone material covers the gap 151. In FIG. 1, the silicone material 140 is bonded to the portions 153, 155 of the paddle 148 and the frame 150. The silicone material 140 has a portion 157 covering the gap 151. The portion 157 can resiliently deform and permit movement of the paddle 148 in directions 162 caused by the motor 116.

The silicone material 140 may be substantially flat or planar throughout the entirety thereof which avoids the use of folds or other features which can capture debris within the receiver 100. The term substantially planar is used with reference to the silicone material 140 to encompass a plane-like shape and slight deviations therefrom. For example, the silicone material 140 may sag or extend into the gap 151 a distance of approximately 75 microns from planar sections of the silicone material 140 bonded to the portions 153, 155 of the paddle 148 and the frame 150.

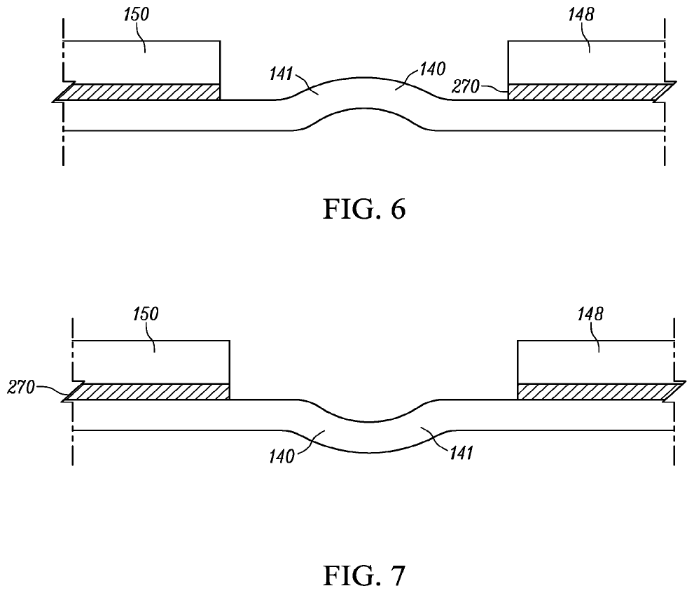

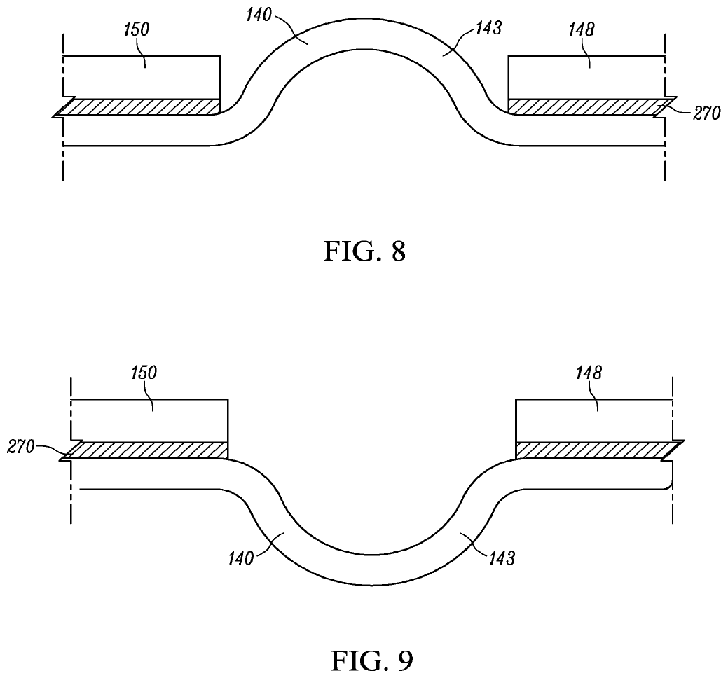

In other forms, the silicone material 140 may not be substantially planar. The silicone material 140 may have portions deviating from planar that provide slack to the silicone material 140. The slack may be greater than 75 microns. As the paddle 148 moves, the slack may be drawn out of these portions to accommodate movement of the paddle 148. Examples of such slack are provided in FIGS. 6 and 7. In FIG. 6, the silicone material 140 has a slack portion 141 with an arc shape extending toward the front volume 142. In FIG. 7, the slack portion 141 with an arc shape extends away from the front volume 142. The silicone material 140 may be on top of or below the paddle 148 and the frame 150. With reference to FIGS. 8 and 9, further examples are provided of geometries of the silicone material 140 that may be used to provide slack in the silicone material 140. In FIG. 8, the silicone material 140 has a roll portion 143 that is larger than the slack portion 141 of FIG. 6. In FIG. 9, the roll portion 143 is larger than the slack portion 141 of FIG. 7.

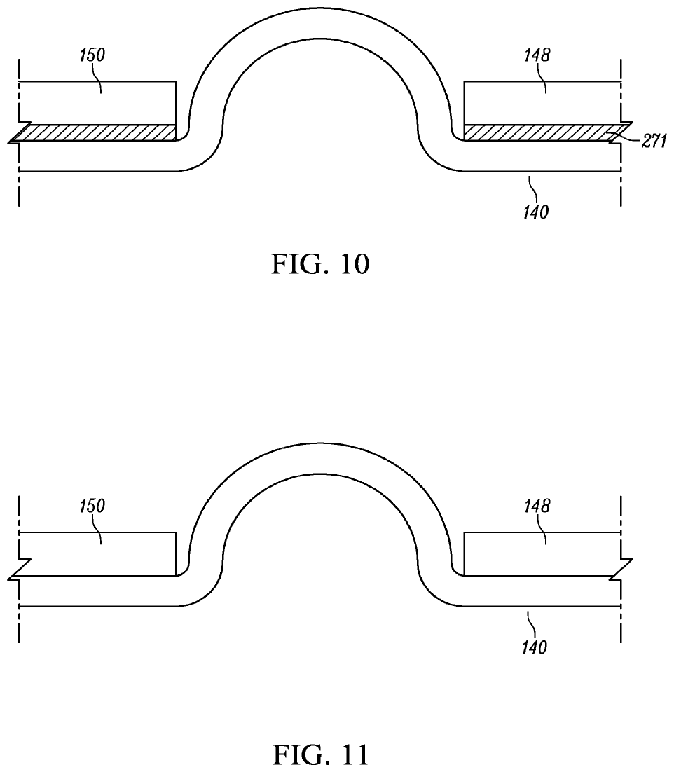

The silicone material 140 may also be molded to have a predetermined non-planar shape and provide slack in the silicone material 140. The silicone material 140 may have a geometry that can be pre-formed or pre-molded into the silicone material 140 prior to the silicone material 140 being connected to the diaphragm body 146. For example, FIG. 10 shows the silicone material 140 having a pre-molded shape and being secured to the frame 150 and paddle 148 with an adhesive or oxide 271. As discussed above, the silicone material 140 may be on top of or below the diaphragm body 146.

In other forms, the silicone material 140 may be molded in place over the diaphragm body 146. For example, FIG. 11 shows the silicone material 140 directly over-molded on the frame 150 and paddle 148. As part of the direct molding, the frame 150 and paddle 148 may be prepared using plasma cleaning. Direct molding may also obviate the need for a separate adhesive or oxide layer. The silicone material 140 may be overmolded to the top or the bottom of the frame 150 and paddle 148, and the arc, roll, or other geometry in the silicone material 140 may extend toward or away from the front volume.

Utilizing slack in the silicone material 140 as discussed above may provide benefits in some applications. For example, the slack may reduce the force required to move the paddle 148 since the slack is taken up rather than deforming the silicone material 140. Another benefit of slack in the silicone material 140 is that the arc or other geometry of the slack better supports differential air pressure leading to a reduction in blow-by effects.

The motor 116 includes a coil 118, a magnetic support structure or yoke 120, and an armature 122. The motor 116 includes at least one magnet 124 defining a space 126 and the coil 118 defines a tunnel 128. The armature 122 may extend through the space 126 and the tunnel 128. The armature 122 is connected to a linkage, such as a rod 130, at one end thereof. In one form, the silicone material 140 has a through opening 152 through which the rod 130 extends and connects to the paddle 148.

Electric currents representing the sounds to be produced are applied to the coil 118 which causes the armature 122 to move in directions 160 and cause resulting movement of the paddle 148 in directions 162. The movement of the paddle 148 creates sound that is directed through a port 166 and into a sound tube 168 of the receiver 100.

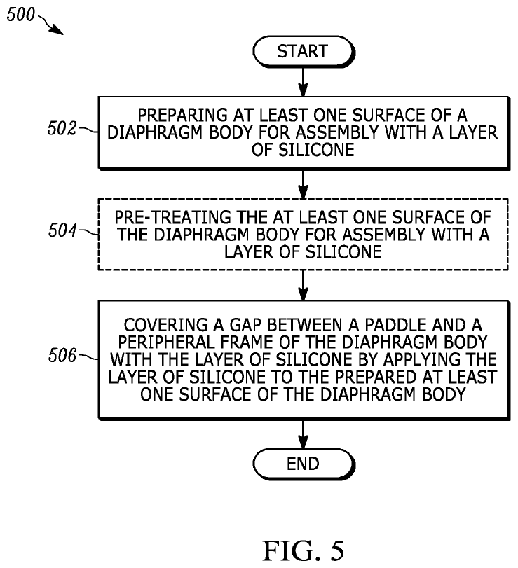

In FIG. 2, the silicone material 140 may be bonded to at least a portion of the paddle 148 and at least a portion of the frame 150. For example, a metal oxide such as silicon oxide 270 may be used to bond the silicone material 140 to the paddle 148 and the frame 150 using the process discussed below with respect to FIG. 5. The silicon oxide 270 bonds directly to the paddle 148, i.e., in the absence of an adhesive or other attachment mechanism.

In one implementation, the silicone material 140 has a thickness of approximately 0.0005 inches, the paddle 148 has a thickness of approximately 0.002 inches, and the silicon oxide 270 is applied to the paddle 148 as a coating having a thickness of 3000 angstroms. These dimensions are merely one example. In other implementations may have other dimensions, which depend generally on the other dimensions of the diaphragm and the performance specification of the receiver. Some of the silicon oxide 270 remains after the silicone material 140 is bonded to the paddle 148. In other approaches, the silicone material 140 may be bonded to the diaphragm body 146 using a silicone-compatible adhesive that is applied to the frame 150 and the paddle 148.

Surface treatment can be employed to enhance bonding of the silicone material 140 to the diaphragm body 146. For example, one or more of the silicone material 140, diaphragm body 146, and bonding agent (such as a metal oxide like silicon oxide 270 or an adhesive) may be exposed to a promoter, plasma, or other treatment that will enhance the bond between the silicone material 140 and the diaphragm body 146.

In one form, the silicone material 140 may be pre-strained. The pre-strain may be applied to the silicone material 140 prior to the silicone material 140 being connected to the paddle 148 and the frame 150. In another approach, the pre-strain may be imparted to the silicone material 140 as the silicone material 140 is connected to the paddle 148 and the frame 150. By utilizing a pre-strain in the silicone material 140, the stiffness of the silicone material 140 may be optimized for a particular application which allows for improved receiver performance and places the silicone material 140 in a state that is easier to handle during production. Further, by applying a pre-tension to the silicone material 140, the silicone material 140 may naturally pull away from cut locations when the silicone material 140 is bonded to the paddle 148 and frame 150. This can make the diaphragm 600 easier to assemble into a receiver and improve yield. Still further, by applying a pre-tension to the silicone material 140, the size and shape of holes formed in the silicone material 140 can be easily controlled.

FIG. 3 illustrates another diaphragm body 300 similar in some respects to the diaphragm body 146 in FIG. 1 and may be utilized with the silicone material 140. The diaphragm body 300 includes a paddle 302, a frame 304, and a generally u-shaped gap 306 separating the paddle 302 and the frame 304. The diaphragm body 300 further includes torsional hinge members 308, 310 connecting the paddle 302 to the frame 304. The torsional hinge members 308, 310 form torsion hinges disposed on opposite sides of the paddle 302. The torsional hinge members 308, 310 are aligned along a common pivot axis 311.

FIG. 4 illustrates another diaphragm body 400 including a paddle 402, a frame 404, and a gap 406 separating the paddle 402 and the frame 404. The diaphragm body 400 further includes cantilever hinge members 408, 410 connecting the paddle 402 to the frame 404 and forming cantilever hinges for the paddle 402. The cantilever hinge members 408, 410 are disposed along a single side of the paddle 402. Like the diaphragm body 300, the diaphragm body 400 can be fabricated from a single, unassembled member or it can be formed as an assembly of separate parts.

The diaphragm bodies 146, 300, 400 may be made of a variety of materials including aluminum, stainless steel, nickel, copper, and combinations thereof. The material may often include metal, metalloids, metalloid oxides or alloys but other materials may be used alternatively.

Turning to FIG. 5, a method 500 is provided for assembling a diaphragm and will be discussed with respect to diaphragm 115. The method 500 includes preparing 502 at least one surface of the diaphragm body 146 for assembly with a layer of siloxane material, such as silicone. For example, surfaces of the paddle 148 and frame 150 that will contact the silicone material 140 may be coated with a 3,000 angstrom thick coating of silicon oxide. In one approach, the layer of silicone material 140 is a portion of a film of silicone material provided from a roll.

At 504, the method 500 optionally includes pre-treating at least one surface of the diaphragm body 146 and the silicone material 140. For example, the paddle 148 and frame 150 coated with silicon oxide 270 and the film of silicone material 140 may be subjected to a plasma etching process. The plasma etch breaks the bonds of the silicon oxide 270 so that when the silicone material 140 is applied it can better bond to the paddle 148 and frame 150.

At 506, the method 500 further includes covering the gap 151 between the paddle 148 and the frame 150 with the silicone material 140 by applying the silicone material 140 to the prepared surface of the diaphragm body 146. For example, applying the silicone material 140 may include applying the silicone material 140 to the silicon oxide-coated surfaces of the paddle 148 and the frame 150. Further, applying the silicone material 140 may also include assembling the silicone material 140 and paddle 148/frame 150 at room temperature after plasma etching and heating the assembled silicone material 140 and the paddle 148/frame 150 for a predetermined time at an elevated temperature.

In one approach, the silicone material 140 may be applied to the diaphragm body 146 by using an apparatus to maintain a film of the silicone material 140 in a flat configuration and shifting the apparatus and silicone material 140 held therein against the paddle 148 and frame 150 which were previously coated with silicon oxide 270. During this application step, a vacuum may be applied to remove air between the film of the silicone material 140 and the paddle 148 and frame 150 and ensure the silicone material 140 lays flat against the paddle 148 and frame 150.

Another advantage of the diaphragm 115 containing the siloxane material, such as the silicone material 140, is that the siloxane material may be resistant to earwax and solvents used to remove debris, such as ear wax, from the receiver 100. For example, and with reference to FIG. 1, the sound tube 168 of the receiver 100 may become clogged with ear wax and ear wax may enter the front volume 142. A solvent may be used to loosen and remove the wax from within the receiver 100. In one approach, the solvent is advanced in direction 176 through the sound tube 168, through the port 166, and into the front volume 142. The solvent may be, for example, hydrogen peroxide, alcohol, a solution of sodium bicarbonate, calcium dobesilate, oil(s), turpentine, and combinations thereof. The solvent may be advanced in direction 176 using a syringe as an example. The solvent travels into the front volume 142 and contacts the diaphragm 115 and may contact at least a portion of the silicone material 140. The solvent also contacts and loosens the wax from the inner surfaces of the sound tube 168 and the front volume 142.

Next, the solvent and ear wax are removed from the receiver 100. In one approach, the syringe may be used to create a vacuum and withdraw the solvent and ear wax from the sound tube 168 and/or the front volume 142. If the front volume 142 has a single port 166 through which sound travels, the process of withdrawing the solvent from the front volume 142 will include withdrawing the solvent through the port 166 which was the same port 166 through which the solvent entered the front volume 142. In another approach, the receiver 100 may be positioned vertically so that the sound port 168 points downwardly and gravity can withdraw the solvent and ear wax from within the receiver 100.

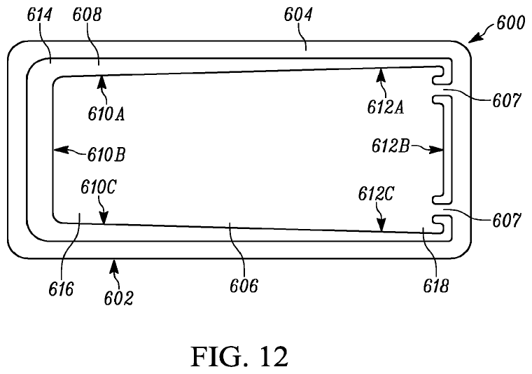

FIG. 12 illustrates another diaphragm 600 having a diaphragm body 602 including a frame 604, a paddle 606, and cantilever hinges 607 connecting the paddle 606 to the frame 604. The diaphragm body 602 has a gap 608 between the paddle 606 and the frame 604 with a width that varies around the paddle 606. More specifically, the gap 608 includes wider portions 610A, 610B, 610C and narrower portions 612A, 612B, 612C. The diaphragm 600 includes a silicone material 614 covering the gap 608. The wider portions 610A, 610B, 610C reduce the stiffness of the diaphragm 600 because there is more silicone material 614 to deform as a distal end 616 of the paddle 606 moves. Another advantage of the varying width of the gap 608 is that the silicone material 614 at the wider portions 610A, 610B, 610C may have a taller or more pronounced profile (see, e.g., FIGS. 6-11) than at the narrower portions 612A, 612B, 612C. The more pronounced profiles of the silicone material 614 at the wider portions 610A, 610B, 610C may resist blow-by of air past the diaphragm 600.

Preferred embodiments of this disclosure are described herein, including the best mode known to the inventor(s). It should be understood that the illustrated embodiments are exemplary only, and should not be taken as limiting the scope of the appended claims.

1.-31. (canceled)

32. A diaphragm for an acoustic receiver, the diaphragm comprising:
a diaphragm body including a paddle movably coupled to the frame by a hinge, the frame disposed about a peripheral portion of the paddle, the paddle separated from the frame by a gap; and
a siloxane material covering the gap, the siloxane material bonded directly to at least a portion of the diaphragm body,
wherein an elastic property of the siloxane material permits the paddle to move relative to the frame upon deformation of the siloxane material.

33. The diaphragm of claim 32, wherein the siloxane material is bonded directly to the diaphragm body without an adhesive.

34. The diaphragm of claim 33, wherein the siloxane material is bonded directly to an oxide of the diaphragm body.

35. The diaphragm of claim 34, wherein the paddle, the frame and the hinge constitute an unassembled unitary member.

36. The diaphragm of claim 32, wherein the siloxane material covering the gap has a substantially planar surface.

37. The diaphragm of claim 36, wherein the substantially planar surface of the siloxane material sags at the gap.

38. The diaphragm of claim 32, wherein the siloxane material is devoid of folds.

39. The diaphragm of claim 32, wherein the siloxane material covering the gap has a non-planar profile.

40. The diaphragm of claim 32, wherein the siloxane material is over molded onto at least a portion of the diaphragm body.

41. The diaphragm of claim 32, the hinge located at one end portion of the paddle, wherein a width of the gap between the paddle and the frame is greater at an end portion of the paddle opposite the hinge.

42. The diaphragm of claim 32, wherein the siloxane material covering the gap is pre-strained.

43. The diaphragm of claim 32 in combination with:
a housing having an interior and a sound port,
the diaphragm disposed in the housing and separating the interior into a back volume and a front volume acoustically coupled to the sound port;
a motor disposed in the back volume, the motor comprising a coil, an armature, and a magnet adjacent the armature, wherein a portion of the armature is free to move relative to the magnet in response to an excitation signal applied to the coil; and
a link interconnecting the armature and the paddle, wherein the paddle moves relative to the frame upon deflection of the armature.

44. A diaphragm for an acoustic receiver, the diaphragm comprising:
a diaphragm body including a paddle move coupled to the frame by a hinge, the frame disposed about a peripheral portion of the paddle, the paddle separated from the frame by a gap;
an oxide layer formed on a surface of the diaphragm body; and
a siloxane material covering the gap, the siloxane material bonded directly to the oxide layer without an adhesive,
wherein an elastic property of the siloxane material permits the paddle to move relative to the frame upon deformation of the siloxane material.

45. The diaphragm of claim 44, wherein the siloxane material covering the gap has a substantially planar surface.

46. The diaphragm of claim 44, wherein the siloxane material covering the gap has a non-planar profile.

47. The diaphragm of claim 44, wherein the siloxane material is over molded onto at least a portion of the diaphragm body.

48. The diaphragm of claim 44 wherein the siloxane material covering the gap is pre-strained.

49. A method of making a diaphragm for an acoustic receiver, the method comprising:
forming a diaphragm body comprising a paddle movably coupled to a peripheral frame by a hinge, the paddle separated from the peripheral frame by a gap; and
directly bonding a siloxane material to at least a portion of the diaphragm body,
wherein a portion of the siloxane material covers the gap between the paddle and the peripheral frame.

50. The method of claim 49, directly bonding the siloxane material to the diaphragm body without adhesive.

51. The method of claim 50, directly bonding the siloxane material to an oxide of the diaphragm body.

52. The method of claim 51 further comprising exposing the siloxane material or the diaphragm body to a plasma before bonding.

53. The method of claim 49 further comprising pre-straining the siloxane material before bonding.

54. The method of claim 49, wherein directly bonding the siloxane material to the diaphragm body includes covering the gap with a substantially planar layer of siloxane material.
